(19) United States
(12) Patent Application Publication
(10) Pub. No.: US 2018/0012249 A1
(43) Pub. Date: Jan. 11, 2018

(54) METHOD AND SYSTEM FOR BIDDING AND PERFORMANCE TRACKING USING ONLINE ADVERTISMENTS

(71) Applicants: Frederick R. Krueger, Santa Monica, CA (US); Dustin Suchter, Santa Moncia, CA (US); Oumar Wone, Santa Monica, CA (US)

(72) Inventors: Frederick R. Krueger, Santa Monica, CA (US); Dustin Suchter, Santa Moncia, CA (US); Oumar Wone, Santa Monica, CA (US)

(21) Appl. No.: 14/960,435

(22) Filed: Dec. 6, 2015

(51) Int. Cl. G06Q 30/02

(52) U.S. Cl. CPC G06Q 30/0242; G06Q 30/0275; G06Q 30/0277

(57) ABSTRACT

The claimed subject matter provides a system and/or a method for using longer term site performance data to better estimate optimal click and impression value for a specific source of online advertising inventory, and to use these estimates to optimally adjust bids for specific audience segments.

### CROSS REFERENCE TO RELATED APPLICATIONS

This application claims priority to U.S. provisional patent application No. 62/060,247, filed on Oct. 6, 2014, entitled “Method And System For Bidding And Performance Tracking Using Online Advertisments.”

### BACKGROUND

In 1988, Goto.com, a site conceived and owned by Idealab of Pasadena, Calif., launched the first pay-for-placement advertising service. GoTo's business model was based on the idea that its paid listings would make it more relevant than other services, especially for general searches, and web sites that pay more are probably better sites.

The idea of having users bid for certain types of advertising inventory was later adapted by Google, and generalized from search terms to various keywords placed on third party sites (Google Adsense). In 2009, Facebook also launched a self-service advertisement platform, where advertisers could bid on specific keywords that its users either explicitly “liked” or were implicit in their user profiles. In addition, Facebook advertisement allowed targeting by location, gender, education level and other self-reported fields.

Google, Facebook and other platforms built around the idea of users bidding on specific keywords and other advertisement attributes also developed application program interfaces (APIs) to allow advertisers to bid on this advertising inventory programmatically—either on a cost per impression (CPM) basis, or on a cost per click (CPC) basis.

In general, advertisers have designed bidding systems to optimally bid on these advertising platforms using a simple performance metric such as the amount of leads collected per thousand clicks or thousand impressions. This metric leads to the concept of “Cost per Lead” or “Cost per Action” that is prevalent in the online advertising world. For example, a mortgage company might value an application for a new mortgage quote at $25 per lead, or an online daily deals site might value an email with an attached zip code at $4 per lead.

Using “Cost Per Lead” as a primary determinant of whether an ad campaign is working or not has resulted in specific bidding algorithms used by advertisers on Google, Facebook and other advertising platforms. However, as advertisers are well aware, leads are just a proxy for the ultimate value delivered by online advertisements. Ultimately, advertisers are interested in the “lifetime customer value (LTV)” of a customer as measured by the amount of profit accruing to the advertiser as a result of acquiring the customer.

Estimating the customer LTV has historically been a difficult problem for advertisers. Over a period of months, advertisers can measure aggregate sales numbers, and estimate future sales trends for a specific “cohort” of acquired customers—but the amount of data involved is substantial and the workflow is complex. Unless the advertiser has a direct connection via API to the ultimate source of advertising traffic driving the customer acquisition it is highly difficult to isolate the different values of different traffic sources and to make intelligent bids (either on a CPM or CPC basis) for this traffic.

### SUMMARY OF THE DISCLOSURE

This disclosure describes a solution to the above-identified problems for the advertiser. Embodiments provide a framework and a method for collecting data by advertising audience segment and campaign, and use this data to automatically and efficiently estimate optimal bidding for a wide variety of segments and campaigns.

Starting initially with simple estimates of value of easily achieved metrics, such as a user registration, or a repeat visitor to the web site, the embodiments described herein progressively refine the estimate of the value of online inventory, and terminates under-performing campaigns early.

The disclosed embodiments include an analytics and marketing dashboard which connects to both an advertising platform and a client application via two Application Programming Interfaces (APIs). When an advertiser creates a campaign on the advertisement platform and a user clicks on an advertisement an ID is created, passed back to the dashboard, and then re-directed to the client. The client then stores that ID and passes back site activity, including sales, via API, linking that activity with the stored user ID.

The dashboard application then analyses the site activity by advertisement campaign and cohort (a date-range specific group of customers) to provide an increasingly better estimate of the lifetime value (LTV) of each customer acquired. This LTV is divided by the number of clicks or impressions to determine the maximum actual value, to the advertiser, of a given number of clicks of impressions to the audience segment. Campaigns with a very low effective value per impression or click can be terminated early to avoid unnecessary ad expense. Other campaigns can be optimized subject to their relative performance metrics.

### BRIEF DESCRIPTION OF THE DRAWINGS

FIG. 1 illustrates a block diagram of a system for collecting performance data from a specific online advertising campaign.

FIG. 2 illustrates a block diagram of a system for estimating an effective cost per thousand impressions (eCPM) and effective cost per clicks (eCPC) using initially an estimated value per lead (VPL) and later an estimate value per acquired customer (VPA).

FIG. 3 illustrates a block diagram for estimating whether a specific campaign should be terminated or the bid price adjusted based on incremental information on sales or other key performance customer indicators.

FIG. 4 illustrates a block diagram for computing an effective value per click (eCPC) or effective value per impression (eCPM), for a specific campaign based on the number of leads acquired over a fixed period, and an assumed value per lead.

FIG. 5 illustrates a block diagram for computing an effective value per click (eCPC) or effective value per impression (eCPM), for a specific campaign based on the number of customers acquired over a fixed period, and an assumed value per customer acquired.

FIG. 6 illustrates a block diagram for computing an effective value per click (eCPC) or effective value per impression (eCPM), for a specific campaign based on the number of sales acquired over a fixed period, and an assumed value per sales acquired.

FIG. 7 illustrates an exemplary networking environment, wherein the novel aspects of the claimed subject matter can be employed.

FIG. 8 illustrates an exemplary operating environment that can be employed in accordance with the claimed subject matter.

### DETAILED DESCRIPTION

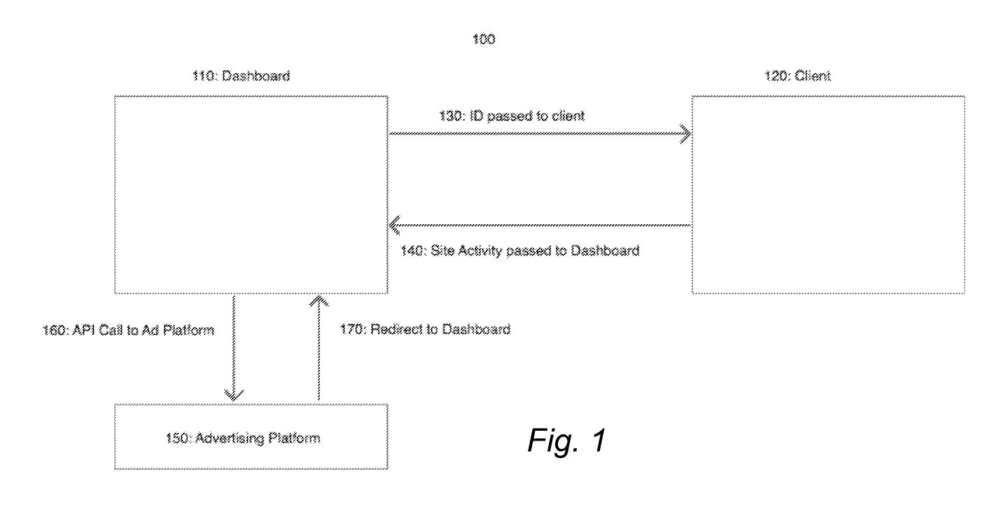

FIG. 1 is a schematic block diagram of a system 100 for collecting performance data from a specific campaign on an Advertising Platform 150, such as Facebook, Google or advertising platform with an Application Programing Interface (API) allowing the placement of bids for specific advertisement inventory.

After the initial ad is placed on the Advertising Platform, every click on the ad is passed back to the Dashboard application and then re-directed to the client application 120. A universal ID is passed to the client, which the client can store together with the cookie of the user. Later, when the user returns to the client website, the client can communicate back to the dashboard application that a return visit has occurred, passing back the ID of the returned visitor. If the user creates an account on the client, the ID can then be saved with the account information (name, email etc), and subsequent activity, including sales activity, can be passed back to the Dashboard 110, via an API call 140.

We note that although the API call is the preferred means of communication with the dashboard application, other mechanisms could also be used, such as a tracking pixel on the client side, to indicate return visits or sales activity. The advantage of a tracking pixel (a standard 1×1 invisible pixel placed on the client application using a simple JavaScript call) is that no programming is required. The disadvantage is that if the user clears their cookies, there is no way to tie the tracking pixel back to the ad campaign where the customer acquisition took place.

With the system described above, different audience segments can be tested, with actual sales numbers being attributable to each segment. For example, one audience segment could consist of women 18-25 years in age living in Miami, Fla., and a second one could consist of males 25-30 years old living in the state of Texas. In both instances, actual sales data is set by the client to dashboard API calls, allowing for the estimation of the relative values of the advertising inventory to the marketer, and a computation of the return on investment, over time, for each group.

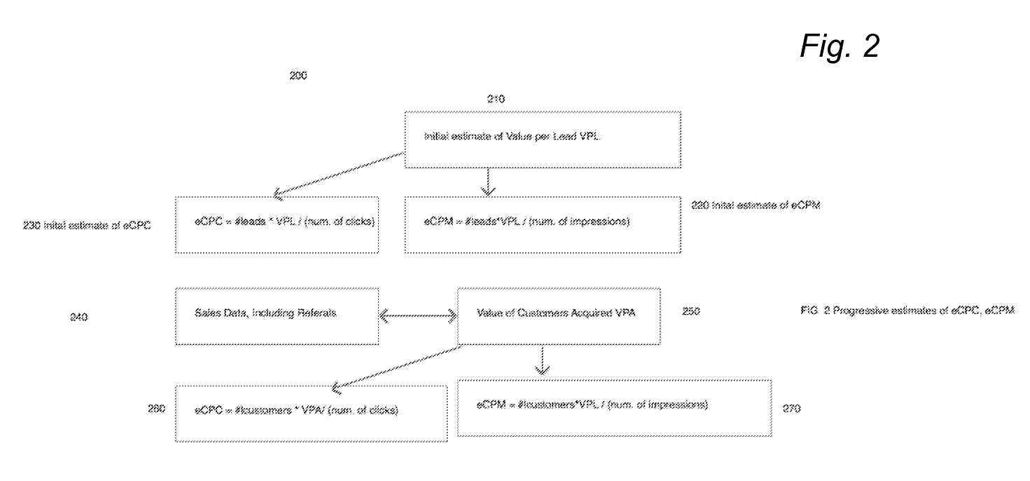

FIG. 2 is a schematic block diagram of a progressive estimation method for computing the effective value of 1,000 impressions (eCPM) and the effective value of a click (eCPC). The method starts with an overall inputted value per lead VPL. In the initial phase of a campaign, the estimated value per 1,000 impressions 220 is simply the average number of leads generated per 1,000 impressions times the inputted value per lead. Similarly, the estimated value per click 230 is the average number of leads generated over a specific number of impression times the inputted value per lead and divided by the number of clicks over the campaign.

As noted earlier, however, the number of leads acquired during any campaign is just a proxy for the total value of all customers acquired by running that campaign. This value per customer can be estimated as a function of the amount of profit generated to the advertiser from that customer, either directly, by virtue of the customer making purchases on the web site, or indirectly by the customer referring other customers.

Once a sufficiently large statistical sample is achieved, a value per customer acquired (VPA) can be estimated (260), and a new eCPM can be calculated (270) by multiplying the number of customers acquired by their value, and dividing by the number of impressions. Similarly, a new eCPC can be calculated (280) by multiplying the number of customers acquired by their value, and dividing by the number of clicks observed in the campaign.

Although estimations of eCPM and eCPC can be derived using this method, we note that the system does not require the actual campaigns to be automatically adjusted based on these numbers. For reasons of campaign deliverability, campaigns may still be run on a fixed CPC or CPM basis, where either number is entered manually, and adjusted by the user according to return on investment metrics as discussed above.

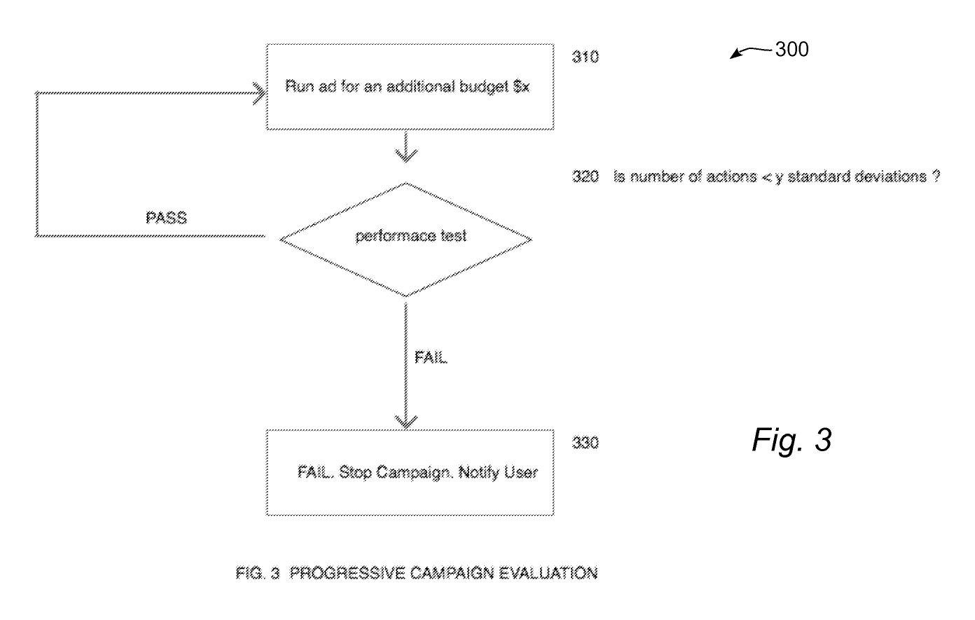

FIG. 3 is a schematic block diagram showing a method for eliminating poorly performing campaigns early, based on a set of successive statistical tests. This method applies in particular to campaigns that are run at a fixed cost per click (CPC) or cost per impression (CPM), or hit the minimum CPC or CPM levels required by the online advertising platform.

The method includes sampling the campaign at fixed budget and time intervals and then determining at each interval whether the number of actions (leads, customers or sales) are significantly below the levels that would be consistent with the hypothesis that the target metrics are met. As an example, suppose that the target cost per customer acquisition over the first week of an advertising campaign was $2. Assume that we ran $4 worth of inventory and that inventory had a weeks worth of time to produce results (and we count no results beyond that week). Assume, for illustration, that the campaign produced 0 sales. In this case, assuming a binomial distribution of sales (independent coin tosses) we would expect to get 2 sales, with a standard deviation of 1.4 (square root of 2). The fact that we ended up with 0 sales, means the sample has less than 2 standard deviations sales than expected, and can be eliminated.

If instead we found that it did produce 2 sales, we would run additional inventory bringing the total spend, say to $8. In that case we would expect to get 4 sales. If the number of sales is still 2, we are still below 2 standard deviations of 4 sales, and the campaign can be paused.

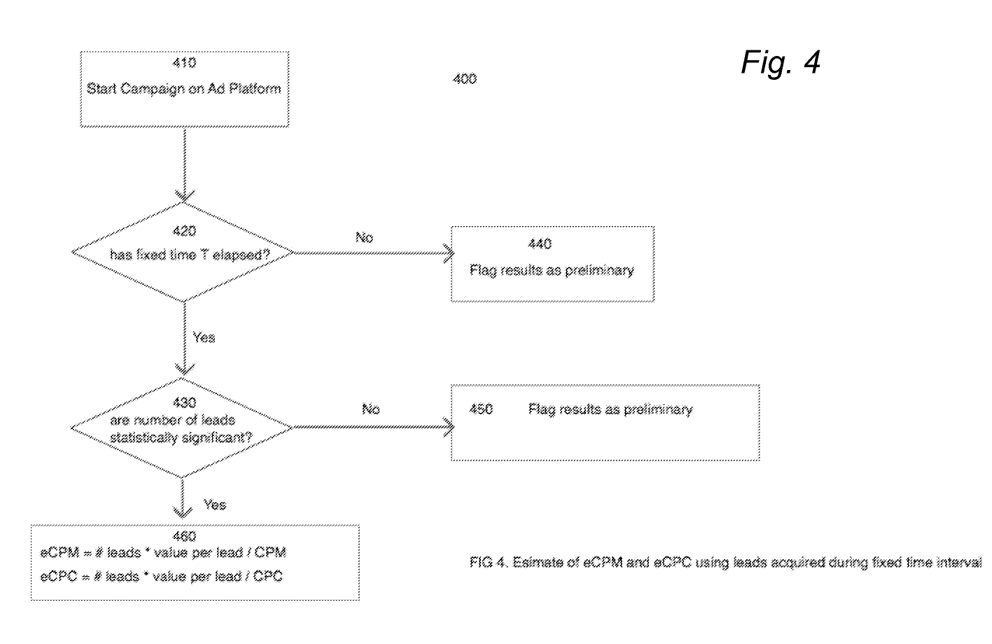

FIG. 4 is a schematic block diagram of a method for estimating the effective cost per click (eCPC) and effective cost per impression (eCPM) using lead data and an assumed cost per lead. Note that marketers often implicitly use crude cost per lead numbers to evaluate the performance of campaigns—but the system here adds a further time element. In particular, we are not interested in total number of leads, but the number of leads acquired over a fixed time frame T.

For example, T might be a week. In this case, we should collect lead data from each click from the ad campaign for a week after the initial click. This allows to account for leads that occurred as a result of customers returning to the website to register for the first time—as opposed to those who simply registered in the same session as the initial click. If the time T has not elapsed (420), the results are flagged as preliminary. Note that any leads acquired after time T are ignored by the calculation, as they could cause the results to not be comparable across campaigns.

We also need to check if the number of leads is statistically significant 430—the methodology of which was previously addressed in the discussion of FIG. 3. If not significant another flag (possibly different from 440) should be raised (450).

If the amount of time T is sufficient, and if the results are statistically significant, multiplying the total number of leads by an assumed value per lead results in an overall dollar value. This number can be divided by the number of impressions and clicks to determine an eCPM and eCPC in 460.

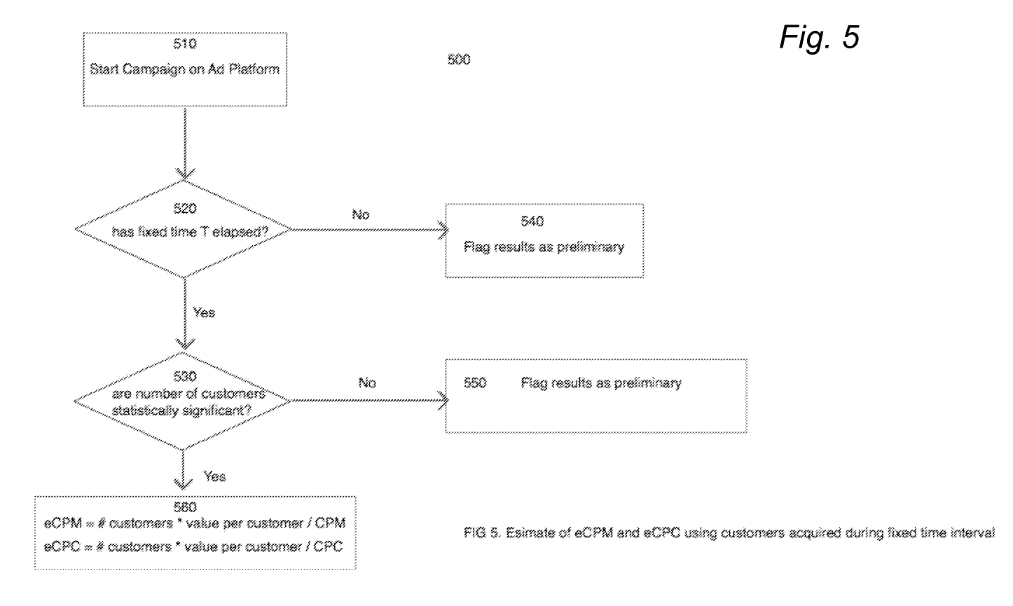

FIG. 5 is a schematic block diagram of a method for estimating the effective cost per click (eCPC) and effective cost per impression (eCPM) using lead data and an assumed cost per customer. Note that the system here adds a further time element—or “cohort”. In particular, we are not interested in total number of customers acquired, but the number of customers acquired over a fixed time frame T.

The importance of T is more significant for customers than it is for leads. It is well known in marketing of online offers that it may take several visits to a website to turn a visitor into a buyer (in the case of a simple lead, usually if the person does not convert immediately they will never return to the website—reducing the impact of time for lead calculation.

For example, T might be one or two weeks. In this case, we should collect lead data from each click from the ad campaign for a time T after the initial click. This allows to account for leads that occurred as a result of customers returning to the website to buy for the first time—as opposed to those who simply bought in the same session as the initial click. If the time T has not elapsed (520), the results are flagged as preliminary. Note that any customers acquired after time T are ignored by the calculation, as they could cause the results to not be comparable across campaigns.

We also need to check if the number of customers is statistically significant 530—the methodology of which was previously addressed in the discussion of FIG. 3. If not significant another flag (possibly different from 540) should be raised (550).

If the amount of time T is sufficient, and if the results are statistically significant, multiplying the total number of customer by an assumed value per customer results in an overall dollar value. This number can be divided by the number of impressions and clicks to determine an eCPM and eCPC in 560.

Note that the value of a customer who buys something in an initial period T is far easier to estimate than the value of a generic lead. By evaluating overall sales data post period T, the marketer can construct a relationship of overall customers acquired over a longer period relative to during the period T. Knowing the overall margin of the business, this implies a certain long term value (LTV) of a customer—something the marketer usually has an assessment of.

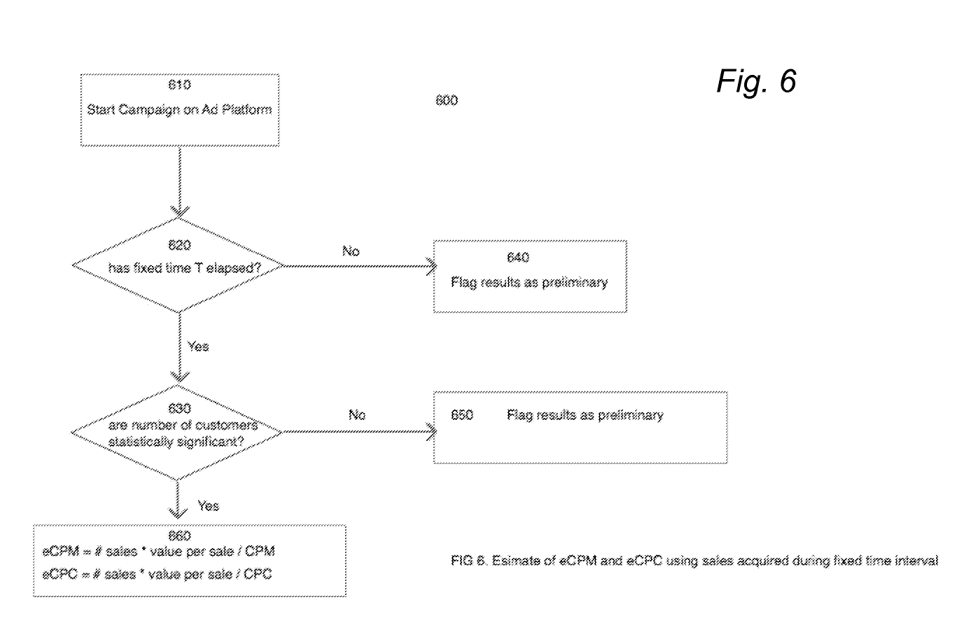

FIG. 6 is a schematic block diagram using sales instead of customers acquired as a key performance metric. The discussion is analogous and will be omitted.

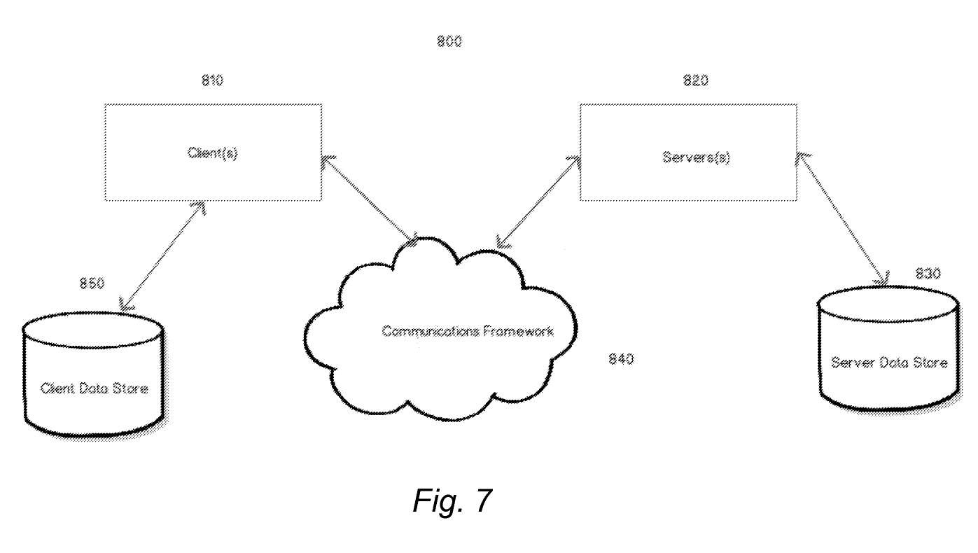

FIG. 7 is a schematic block diagram of a sample-computing environment 800 with which the claimed subject matter can interact. The system 800 includes one or more client(s) 810. The client(s) 810 can be hardware and/or software (e.g., threads, processes, computing devices). The system 800 also includes one or more server(s) 820. The server(s) 820 can be hardware and/or software (e.g., threads, processes, computing devices). The servers 820 can house threads to perform transformations by employing the subject innovation, for example.

One possible communication between a client 810 and a server 820 can be in the form of a data packet adapted to be transmitted between two or more computer processes. The system 800 includes a communication framework 840 that can be employed to facilitate communications between the client(s) 810 and the server(s) 820. The client(s) 810 are operably connected to one or more client data store(s) 850 that can be employed to store information local to the client(s) 810. Similarly, the server(s) 820 are operably connected to one or more server data store(s) 830 that can be employed to store information local to the servers 820.

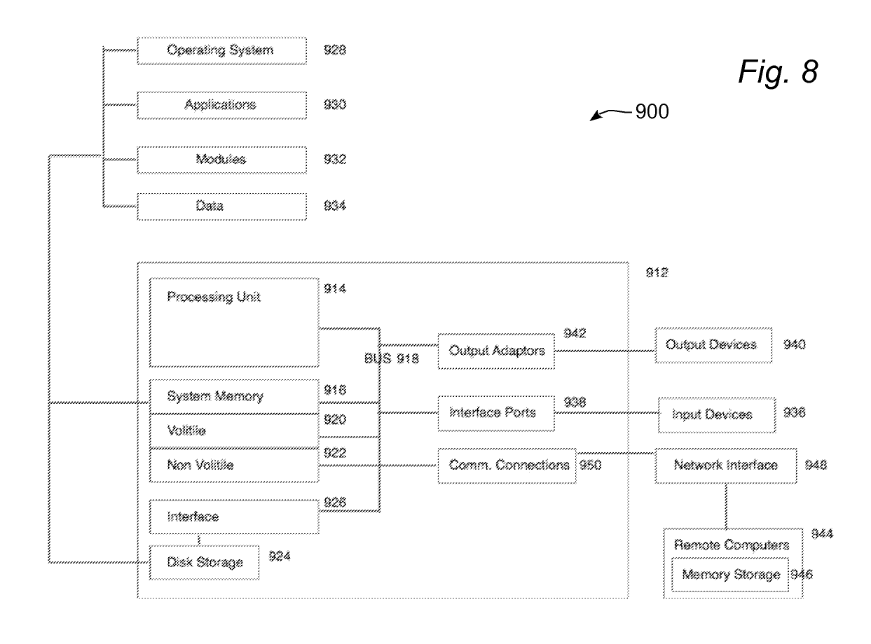

With reference to FIG. 8, an exemplary environment 900 for implementing various aspects of the claimed subject matter includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable programmable ROM (EEPROM), or flash memory. Volatile memory 920 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 912 also includes removable/non-removable, volatile/non-volatile computer storage media. FIG. 8 illustrates, for example a disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 8 describes software that acts as an intermediary between users and the basic computer resources described in the suitable operating environment 900. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that the claimed subject matter can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940, which require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

1. A system that facilitates the estimation of optimal bidding for a specific audience segment, comprising:
a dashboard application that provides the user with analytics on advertising performance;
a third party advertising system that communicates with the dashboard via an application program interface (API); and
a client application that communicates with the dashboard via a tracking pixel or a separate API.

2. The system recited in claim 1, incorporating a method for refining an estimate of the effective value of 1,000 impressions (eCPM) or the effective value of a click (eCPC), based initially on the number of leads acquired during a campaign, attributing a fixed value per lead across all campaigns.

3. The system recited in claim 1, incorporating a method for refining an estimate of the effective value of 1,000 impressions (eCPM) or the effective value of a click (eCPC), based on the number of new customers acquired during a fixed period at the start of a campaign, and attributing a fixed value for each such customer.

4. The system recited in claim 1, incorporating a method for refining an estimate of the effective value of 1,000 impressions (eCPM) or the effective value of a click (eCPC), based on the number of new sales acquired during a fixed period at the start of a campaign, and attributing a fixed value for each sale. This is distinct from claim 3, as a given customer might have make multiple sales over a fixed period of time.

5. The system recited in claim 2, 3 or 4 where the actual CPC or CPM bid is automatically modified as a function of the computed values using either the value per lead, the value per customers acquired, or the value per sale over a specific time frame.

6. The system recited in claim 1, where the campaign is run at a fixed cost per click (CPC) or fixed cost per impression (CPM) with a method for progressively terminating the campaign based on incremental sales data. At specific pre-determined intervals, the system applies confidence intervals based on the normal distribution to eliminate under-performing campaigns.

7. The system recited in claim 1, where the standard deviation of the eCPM and eCPC are calculated and reported, using a normal approximation to the binomial distribution based on the number of actions in a specific period, and an assumption on how total sales over a customer lifetime relate to sales over a specific period.
